(19) United States
(12) Patent Application Publication
(10) Pub. No.: US 2018/0141639 A1
(43) Pub. Date: May 24, 2018

(54) PROPELLER TRANSFER TUBE

(71) Applicant: Ratier-Figeac SAS, Figeac (FR)

(72) Inventor: Christian FAGES, Saint-Felix (FR)

(21) Appl. No.: 15/807,848

(22) Filed: Nov. 9, 2017

(30) Foreign Application Priority Data
Nov. 22, 2016 (EP) 16306536.0

(51) Int. Cl. B64C 11/38; B33Y 80/00

(52) U.S. Cl. CPC B64C 11/385; B33Y 10/00; B33Y 80/00

(57) ABSTRACT

A transfer tube for a variable pitch propeller is provided, comprising a single piece having at least one channel formed therein for transferring hydraulic fluid. The transfer tube is an additively manufactured transfer tube integrally formed as one piece. The transfer tube may comprise a first channel (3_{I}) for transferring hydraulic fluid to an increase pitch chamber in a pitch change actuation mechanism, a second channel (3_{D}) for transferring hydraulic fluid to a decrease pitch chamber in the pitch change actuation mechanism and a third channel (3_{P}) for transferring hydraulic fluid to a pitchlock mechanism. The transfer tube may comprise an integrated manifold portion additively manufactured as one piece as part of the transfer tube.

### FOREIGN PRIORITY

This application claims priority to European Patent Application No. 16306536.0 filed Nov. 22, 2016, the entire contents of which is incorporated herein by reference.

### TECHNICAL FIELD

The present disclosure relates to a propeller transfer tube. In particular, a transfer tube for use with a variable-pitch propeller.

### BACKGROUND OF THE INVENTION

Variable pitch propellers are employed on many different types of vehicles, such as aircraft. Typically, propeller blades are mounted to a rotary hub for pivotable movement about their longitudinal axis to permit pitch adjustment. The pitch adjustment is effected by an hydraulic pitch change actuator housed within the rotating hub assembly. The pitch change actuator is controlled by a flow metering valve such as an electrohydraulic servo valve or direct drive servo valve, which supplies high pressure oil to the pitch change actuator. The flow metering valve is mounted on the static part of the propeller, e.g. the propeller gearbox, and the high pressure hydraulic fluid, e.g. oil, is supplied to the pitch change actuator via a transfer bearing (which interfaces the non-rotatable portion of the propeller with the rotatable portion) and a transfer tube (which may include one or more channels for transferring one or more oil supplies). The transfer tube typically extends into a manifold which has passages for delivering the hydraulic fluid from the transfer tube to the pitch actuation mechanism.

One such variable pitch propeller system, comprising a transfer tube to deliver hydraulic fluid from a transfer bearing to a pitch change actuation mechanism, is described in U.S. Pat. No. 6,077,040.

Prior art transfer tubes are typically made from many tube portions joined together. It is not uncommon for a transfer tube to be assembled from more than twenty parts. Seals are used to try and prevent leakage between the various assembled parts. However, the seals may not be perfect, or may degrade over time, resulting in leakage of hydraulic fluid.

### SUMMARY

From one aspect, the present disclosure provides a transfer tube for a variable pitch propeller, wherein the transfer tube comprises a single piece having at least one channel formed therein for transferring hydraulic fluid; and the transfer tube is an additively manufactured transfer tube integrally formed as one piece.

In embodiments, the transfer tube may comprise a first channel for transferring hydraulic fluid to an increase pitch chamber in a pitch change actuation mechanism and a second channel for transferring hydraulic fluid to a decrease pitch chamber in the pitch change actuation mechanism. The transfer tube may comprise a third channel for transferring hydraulic fluid to a pitchlock mechanism.

In embodiments, the transfer tube is additively manufactured from titanium or steel. In embodiments, the at least one channel has a portion thereof that does not intersect with an outer surface of the transfer tube.

The transfer tube may further comprise an integrated manifold portion additively manufactured as one piece as part of the transfer tube such that together the integrated manifold portion and the transfer tube comprise a single piece. The manifold portion may comprise exit ports for directing fluid in the channel(s) to a pitch change actuation mechanism.

The transfer tube may comprise exit ports for directing fluid in the channel(s) to a manifold.

In embodiments, the above described exit ports in the manifold portion or exit ports in the transfer tube are perpendicular to the longitudinal axis of the transfer tube.

In embodiments, at least a portion of the transfer tube between each end is accordion-shaped in the longitudinal direction to provide flexibility, preferably comprising zig-zag bends or corrugations.

The present disclosure further extends to a variable pitch propeller comprising a transfer tube according to the first aspect as described above, wherein the transfer tube is arranged to transfer hydraulic fluid via the channel(s) therein from a flow metering valve to a pitch change actuation mechanism. The disclosure further extends to an aircraft comprising such a variable pitch propeller.

The present disclosure also provides a method of manufacturing a transfer tube for a variable pitch propeller, the transfer tube having at least one channel for transferring hydraulic fluid, comprising integrally forming the transfer tube as one piece by an additive manufacturing process. The additive manufacturing process may comprise at least one of: selective laser sintering, selective laser melting, direct metal deposition, direct metal laser sintering, direct metal laser melting and electron beam melting.

In embodiments, the method of manufacturing a transfer tube may further comprise additively manufacturing an integrated manifold portion as part of the transfer tube. In embodiments, the method may comprise manufacturing exit ports in the transfer tube or the integrated manifold portion at a direction perpendicular to the longitudinal axis of the transfer tube.

### BRIEF DESCRIPTION OF THE DRAWINGS

Preferred embodiments of the present disclosure will now be described by way of example only and with reference to the accompanying drawings, in which:

FIG. 1 illustrates a transfer tube according to a first embodiment of the present disclosure;

FIG. 2 illustrates a transfer tube according to a second embodiment of the present disclosure;

FIG. 3 illustrates the portion B of the transfer tube marked with a circle in FIG. 1, but modified to have an accordion-shape;

FIG. 4a shows a simplified cross-section of channels of a transfer tube arranged side by side; and

FIG. 4b shows a simplified cross-section of channels of a transfer tube arranged to overlap.

### DETAILED DESCRIPTION

A first embodiment of a transfer tube 10 for a variable pitch propeller according to the present disclosure is illustrated in FIG. 1. Each end of the transfer tube 10 is shown, but the central portion is omitted for ease of representation.

The transfer tube 10 comprises feed holes 2 (input ports) and has channels 3 formed therein. Specifically, it comprises increase pitch feed holes 2I through which hydraulic fluid can be provided to increase pitch channels 3I; decrease pitch feed holes 2D through which hydraulic fluid can be provided to decrease pitch channels 3D; and pitchlock feed holes 2P through which hydraulic fluid can be provided to pitchlock channel 3P. Channels 3 may alternatively be referred to as pipes.

The transfer tube comprises an integrated manifold portion 4 having exit holes 12 (which may also be termed exit ports or exit channels). Specifically, it comprises increase pitch exit hole 12I and decrease pitch exit hole 12D at the end of the manifold. The pitchlock channel 3P has a an exit hole 12P that communicates with a tube 13. Tube 13 directs the fluid to a pitchlock mechanism. In use when installed in a variable pitch propeller, a transfer bearing (not shown) provides hydraulic fluid (e.g. oil) to the three feed holes 2I, 2D and 2P. The manifold portion 4 carries hydraulic fluid to the pitch change actuation mechanism by redirecting hydraulic fluid in the channels 3 via exit holes 12I, 12D and 12P to the increase pitch and decrease pitch chambers of a pitch change actuator and to the pitchlock mechanism (via tube 13) of the propeller respectively. The pitchlock mechanism may be considered as part of the pitch change actuation mechanism. These mechanisms are well known and will not be described in further detail here.

The transfer tube 10 is formed as a single piece, i.e. is integrally formed, for example comprises no joints, using additive manufacturing methods and thus may be considered as an additively manufactured transfer tube. Thus, the transfer tube 10 may be considered as “seamless”. This offers significant advantages over prior art transfer tubes. As described above, prior art transfer tubes are made from many tube portions joined together and leakage can occur if seals are imperfect between the various assembled parts. By forming the transfer tube 10 integrally as one piece by additive manufacturing, there are no joints between assembled parts and thus there can be no risk of leakage. Furthermore, it removes the need for the manufacture and assembly of individual component parts and so manufacture is quicker and cheaper. It also avoids points of structural weakness caused by connections between component parts in the prior art.

In addition to the transfer tube comprising a single piece, various other structural differences may result from the transfer tube being an additively manufactured transfer tube. For example, at least one channel may have a portion thereof that does not intersect with an outer surface of the transfer tube.

A further advantage concerns the sizing of the channels 3. In the prior art, the requirement for seals between pipe joints requires a minimum pipe diameter in order for the seals to work. However, in the transfer tube 10 of the present disclosure, since no joints exist and thus no seals are required, no minimum pipe (channel) diameter is set as a result of seals. Consequently, the diameter of the channels (pipes) can be optimised based on the requirements of the particular propeller rather than being limited by the seals. As a result, the channels can be made with a smaller diameter than in the prior art, reducing the size and therefore the weight and cost of the transfer tube. Furthermore, the overall quantity of circulating hydraulic fluid required will be less, resulting in a further weight and cost saving.

Yet another advantage of the transfer tube being additively manufactured concerns the exit holes 12. Whilst the exit holes 12 are illustrated in FIG. 1 as exiting the transfer tube axially, i.e. at the end of the transfer tube 10, in another embodiment the exit holes 12 are perpendicular to the axis A-A of the transfer tube 10. This prevents the generation of axial loads due to pressure, i.e. prevents the generation of unbalanced axial forces between the transfer tube and other components of the propeller which may result if the exit holes 12 are at the end of the transfer tube 10. The additive manufacturing process enables the transfer tube 10 to be manufactured in this way to have exit holes 12 at 90° to the axis A-A and channels 3, in a single part, without the requirement for plugs.

The transfer tube 10 may be additively manufactured from titanium or steel. It may also be additively manufactured from more than one material. For example a hard surface may be required at the extremity of the transfer tube to avoid wear, thus a hard material should be used for the outer portions of the transfer tube, whilst a less hard material such as aluminium could be used for the inner parts. This is possible through additive manufacturing.

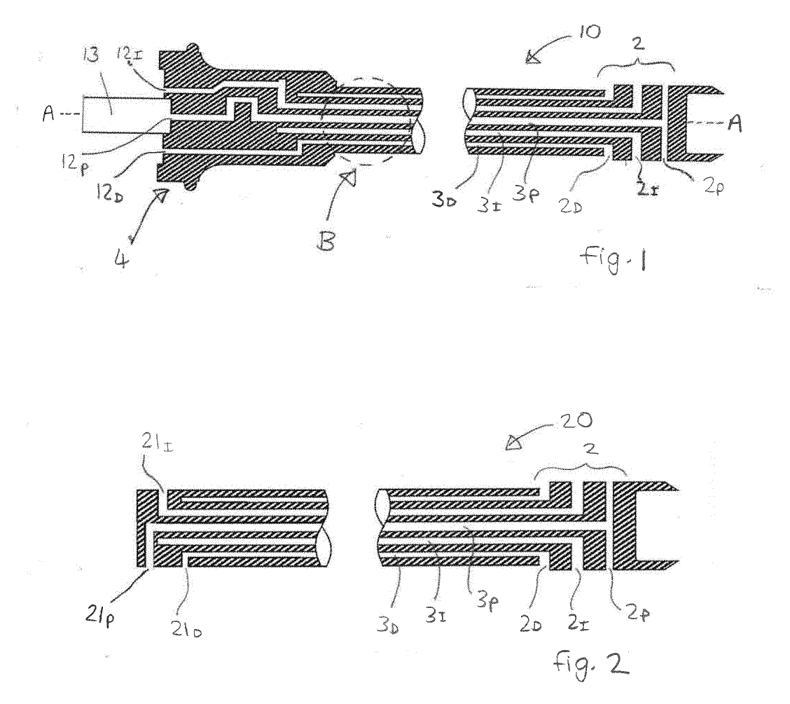

In the above described embodiment the transfer tube comprises an integrated manifold portion 4 formed as part of the transfer tube during the additive manufacturing process (i.e. the integrated manifold portion 4 and the transfer tube comprise one piece). This is advantageous since it avoids the need for the transfer tube to be assembled with a separate manifold, thus saving time and cost. However in other embodiments, a manifold portion is not integrated with the transfer tube. Rather, the transfer tube is additively manufactured, and is then connected to a separate manifold. Such an embodiment is illustrated in FIG. 2.

In the second embodiment of FIG. 2, the transfer tube 20 comprises feed holes 2 and channels 3 just as in the first embodiment. Specifically, it comprises increase pitch feed holes 2I through which hydraulic fluid can be provided to increase pitch channels 3I; decrease pitch feed holes 2D through which hydraulic fluid can be provided to decrease pitch channels 3D; and pitchlock feed holes 2P through which hydraulic fluid can be provided to pitchlock channel 3P, just as in the first embodiment. Also, just as in the first embodiment, the transfer tube 20 is formed as a single piece, i.e. is integrally formed, using additive manufacturing methods, and consequently has all the advantages associated therewith. However, instead of having an integrated manifold portion 4 as in the first embodiment, the fluid in the channels 3I, 3D and 3P exits the transfer tube 20 at exit ports 21I, 21D and 21P, and then enters a separate manifold (not shown). In this embodiment, the exit ports 21 are perpendicular to the axis of the transfer tube 20. This prevents the generation of axial loads due to pressure, i.e. prevents the generation of unbalanced axial forces between the transfer tube and other components of the propeller which may result if the exit holes 2I are at the end of the transfer tube 10. The additive manufacturing process enables the transfer tube 20 to be manufactured in this way to have exit holes 2I at 90° to both the axis and channels 3, in a single part, without the requirement for plugs.

In some situations the integrated manifold configuration of the first embodiment may be more desirable as being simpler and requiring less separate parts, but there may be situations in which a separate manifold portion is more desirable.

If a transfer tube 10, 20 according to embodiments of the disclosure is to be fitted in an existing space in a propeller, and the transfer tube 10, 20 is advantageously made with a smaller diameter than the existing space in the propeller due to being additively manufactured, then ribs (for example made of steel) may be added to the outside of the transfer tube so that the transfer tube fits in the existing space. Such ribs also reinforce the transfer tube.

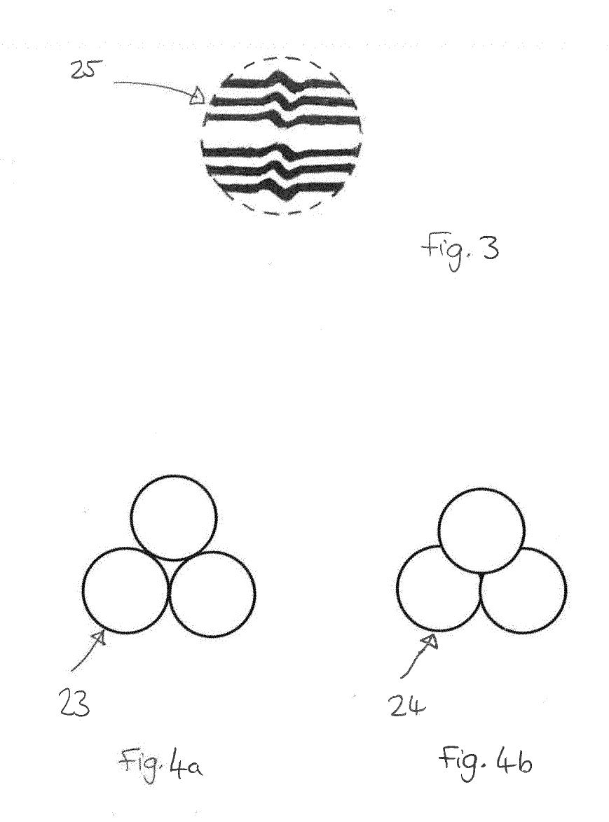

In each of the illustrated embodiments, the main portion of the transfer tube having the channels 3 (and including the omitted central portion) is straight. However, in other embodiments, it may be “accordion-shaped” (e.g. concertina-shaped) to provide some flexibility to allow for deflection of the transfer tube 1. An example of this is shown in FIG. 3, which is an enlarged view of the portion B marked with a circle in FIG. 1 but modified to have an accordion-shape 25. As can be seen, in this modified example, the tube incorporates zig-zag bends 25 (which may also be termed corrugations) which provide flexibility. Flexibility is useful, for example, to allow for misalignment between the propeller shaft and gearbox connected by the transfer tube.

Whilst in the illustrated embodiments the channels 3 are arranged concentrically, in other embodiments they may be arranged side by side in order to optimise the volume:weight ratio, and reduce cost. FIG. 4a is a simplified sectional view of channels 23 of a transfer tube (e.g. increase pitch, decrease pitch and pitchlock) arranged side by side. In other embodiments the channels may be joined together, as shown for example in FIG. 4b which is a simplified sectional view of channels 24 of a transfer tube which are joined together.

It will be appreciated that where feed holes (input ports) 2 are referred to, in some embodiments these may alternatively be exit holes (exit ports). Similarly, where exit holes (ports) 12 are referred to, these may alternatively be feed holes (input ports).

Regarding the manufacture of the transfer tube 10 by additive manufacturing, it will be appreciated by the skilled person that the term “additive manufacturing” may describe a process where an additive manufacturing system builds up a part or parts in a layer-by-layer fashion. For example, for each layer, the additive manufacturing system may spread and compact a layer of additive manufacturing material (e.g., metal powder and/or non-metal powder) and solidify one or more portions of this material layer with an energy beam; e.g., a laser beam or an electron beam. The process may be repeated thousands of times until a finished three dimensional part is produced.

Any suitable known additive manufacturing process may be used for the manufacture of the transfer tube of the present disclosure. For example, the additive manufacturing process may comprise at least one of: selective laser sintering, selective laser melting, direct metal deposition, direct metal laser sintering, direct metal laser melting and electron beam melting. Since the transfer tube is produced in a continuous process in the additive manufacturing method, features associated with conventional manufacturing processes such as machining, forging, welding, casting etc. are eliminated thus resulting in savings in cost, material and time. The skilled person would appreciate that a process may be selected based on the geometry of the transfer tube to be manufactured.

While the apparatus and methods of the subject disclosure have been shown and described with reference to embodiments, those skilled in the art will readily appreciate that changes and/or modifications may be made thereto without departing from the scope of the subject disclosure.

1. A transfer tube for a variable pitch propeller, wherein
the transfer tube comprises a single piece having at least one channel formed therein for transferring hydraulic fluid; and
the transfer tube is an additively manufactured transfer tube integrally formed as one piece.

2. A transfer tube as claimed in claim 1, comprising a first channel (3_{I}) for transferring hydraulic fluid to an increase pitch chamber in a pitch change actuation mechanism and a second channel (3_{D}) for transferring hydraulic fluid to a decrease pitch chamber in the pitch change actuation mechanism.

3. A transfer tube as claimed in claim 2, comprising a third channel (3_{P}) for transferring hydraulic fluid to a pitchlock mechanism.

4. A transfer tube as claimed in claim 1, wherein the transfer tube is additively manufactured from titanium or steel; and/or wherein the at least one channel has a portion thereof that does not intersect with an outer surface of the transfer tube.

5. A transfer tube as claimed in claim 1, further comprising an integrated manifold portion additively manufactured as one piece as part of the transfer tube such that together the integrated manifold portion and the transfer tube comprise a single piece.

6. A transfer tube as claimed in claim 5, wherein the manifold portion comprises exit ports for directing fluid in the channel(s) to a pitch change actuation mechanism.

7. A transfer tube as claimed in claim 1, wherein the transfer tube comprises exit ports for directing fluid in the channel(s) to a manifold.

8. A transfer tube as claimed in claim 7, wherein the exit ports in the manifold portion or exit ports in the transfer tube are perpendicular to the longitudinal axis of the transfer tube.

9. A transfer tube as claimed in claim 1, wherein at least a portion of the transfer tube between each end is accordion-shaped in the longitudinal direction to provide flexibility, preferably comprising zig-zag bends or corrugations.

10. A variable pitch propeller comprising a transfer tube as claimed in claim 1, wherein the transfer tube is arranged to transfer hydraulic fluid via the channel(s) therein from a flow metering valve to a pitch change actuation mechanism.

11. An aircraft comprising:
a variable pitch propeller, the propeller including:
a transfer tube wherein the transfer tube comprises a single piece having at least one channel formed therein for transferring hydraulic fluid; and the transfer tube is an additively manufactured transfer tube integrally formed as one piece.

12. A method of manufacturing a transfer tube for a variable pitch propeller, the transfer tube having at least one channel for transferring hydraulic fluid, comprising integrally forming the transfer tube as one piece by an additive manufacturing process.

13. A method of manufacturing a transfer tube as claimed in claim 12, wherein the additive manufacturing process comprises at least one of: selective laser sintering, selective laser melting, direct metal deposition, direct metal laser sintering, direct metal laser melting and electron beam melting.

14. A method of manufacturing a transfer tube as claimed in claim 12, further comprising additively manufacturing an integrated manifold portion as part of the transfer tube.

15. A method of manufacturing a transfer tube as claimed in claim 12, further comprising manufacturing exit ports in the transfer tube or the integrated manifold portion at a direction perpendicular to the longitudinal axis of the transfer tube.
